(19) United States
(12) Patent Application Publication
(10) Pub. No.: US 2008/0047025 A1
(43) Pub. Date: Feb. 21, 2008

(54) Smart card having security apparatus with minimized area

(76) Inventor: Eui-Seung Kim, Suwon-si (KR)

Correspondence Address: LAW OFFICE OF MONICA H CHOI, P O BOX 3424, DUBLIN, OH, 430160204, US

(21) Appl. No.: 11/606,600

(22) Filed: Nov. 30, 2006

(30) Foreign Application Priority Data
Aug. 11, 2006 (KR) 2006-76263

(51) Int. Cl. G06F 11/00; H04L 9/32; G08B 13/14

(52) U.S. Cl. 726/35; 726/27; 340/568.1

(57) ABSTRACT

A security apparatus within a smart card includes a plurality of security blocks with at least one shared component. Each security block that when activated generates a respective output signal indicating whether a respective detected parameter is within a respective acceptable range. A selecting unit couples the shared component to the activated one of the security blocks for minimized area and cost of the security apparatus.

### CROSS-REFERENCE TO RELATED APPLICATION(S)

The present application claims priority under 35 U.S.C. §119 to Korean Patent Application No. 2006-76263, filed on Aug. 11, 2006, which is incorporated herein by reference in its entirety.

### TECHNICAL FIELD

The present invention relates generally to smart cards, and more particularly, to a security apparatus having at least one shared component for minimizing the area of the security apparatus within a smart card.

### BACKGROUND OF THE INVENTION

FIG. 1 shows a block diagram of a security apparatus 100 in a smart card of the prior art. The security apparatus 100 includes a first detector 102, a second detector 104, and a third detector 106. Each of the detectors 102, 104, and 106 includes circuitry for detecting a respective parameter that may indicate whether a hacker is accessing the security card.

For example, each of the detectors 102, 104, and 106 detects for a voltage, temperature, frequency, or light intensity parameter. For instance, the first detector 102 receives a first input signal IN1 from a temperature sensor, the second detector 104 receives a second input signal IN2 from a frequency sensor, and the third detector 106 receives a third input signal IN3 from a light sensor.

The first detector 102 includes a first measuring unit 108 having a first MOSFET (metal oxide semiconductor field effect transistor) unit 110, a first resistor unit 112, a first capacitor unit 114, and a first unique block 116. The first measuring unit 108 generates a first voltage signal VI1 indicating the magnitude of the temperature from the first input signal IN1.

The first voltage signal VI1 is input to a first comparator 118. The first comparator 118 compares the first voltage signal VI1 with a first reference voltage Vref1 to generate a first detection signal DET1. The first detection signal DET1 is activated to a logical high state when the first voltage signal VI1 is greater than the first reference voltage Vref1 and is deactivated to the logical low state other-wise.

The second detector 104 includes a second measuring unit 120 having a second MOSFET unit 122, a second resistor unit 124, a second capacitor unit 126, and a second unique block 128. The second measuring unit 128 generates a second voltage signal VI2 indicating the magnitude of the sensed frequency from the second input signal IN2.

The second voltage signal VI2 is input to a second comparator 130. The second comparator 130 compares the second voltage signal VI2 with a second reference voltage Vref2 to generate a second detection signal DET2. The second detection signal DET2 is activated to a logical high state when the second voltage signal VI2 is greater than the second reference voltage Vref2 and is deactivated to the logical low state other-wise.

The third detector 106 includes a third measuring unit 132 having a third MOSFET unit 134, a third resistor unit 136, a third capacitor unit 138, and a third unique block 140. The third measuring unit 132 generates a third voltage signal VI3 indicating the magnitude of the sensed light from the third input signal IN3.

The third voltage signal VI3 is input to a third comparator 142. The third comparator 142 compares the third voltage signal VI3 with a third reference voltage Vref3 to generate a third detection signal DET3. The third detection signal DET3 is activated to a logical high state when the third voltage signal VI3 is greater than the third reference voltage Vref3 and is deactivated to the logical low state other-wise.

The security apparatus 100 further includes a reset control unit 144 that generates a reset signal RST from the detection signals DET1, DET2, and DET3. If any of the detection signals DET1, DET2, and DET3 is activated, the reset control unit 144 activates the reset signal RST to the logical high state.

Each of the unique blocks 116, 128, and 140 includes respective circuit components used for generating the voltage signals VI1, VI2, and VI3, respectively. FIG. 2A illustrates an example of the first measuring unit 108 having a PMOSFET (P-channel metal oxide semiconductor field effect transistor) MP1 and an NMOSFET (N-channel metal oxide semiconductor field effect transistor) MN1 for the first MOSFET unit 110A and 110B, a resistor R1 for the first resistor unit 112, and a capacitor C1 for the first capacitor unit 114.

FIG. 2B illustrates an example of the second measuring unit 120 having PMOSFETs MP2 and MP3 and NMOSFETs MN2 and MN3 for the second MOSFET unit 122A and 122B, resistors R2 and R3 for the second resistor unit 124, and capacitors C2 and C3 for the second capacitor unit 126. FIG. 2C illustrates an example of the third measuring unit 132 having PMOSFETs MP4, MP5, and MP6 and NMOSFETs MN4, MN5, and MN6 for the third MOSFET unit 134A and 134B, resistors R4, R5, and R6 for the third resistor unit 136, and capacitors C4, C5, and C6 for the third capacitor unit 138.

The security apparatus 100 in the smart card of the prior art includes many components including the plurality of detectors 102, 104, and 106 with respective MOSFET units, respective resistor units, respective capacitor units, respective unique circuit blocks, and respective comparators. Such numerous components disadvantageously increase the circuit area and the cost for implementing the security apparatus 100 in the smart card of the prior art.

### SUMMARY OF THE INVENTION

Accordingly, in a general aspect of the present invention, detectors in a security apparatus of a smart card share at least one component for minimized circuit area and cost.

A security apparatus within a smart card according to a general aspect of the present invention includes a plurality of security blocks, at least one shared component, and a selecting unit. Each security block that when activated generates a respective output signal indicating whether a respective detected parameter is within a respective acceptable range. The selecting unit couples the at least one shared component to the activated one of the security blocks.

In another embodiment of the present invention, the security apparatus includes a plurality of components and a switching unit for determining which of the plurality of components is coupled to the activated one of the security blocks.

In an example embodiment of the present invention, the plurality of components includes a plurality of resistors, a plurality of capacitors, and a plurality of transistors.

In another embodiment of the present invention, the security apparatus includes a switching unit that selects the respective output signal from the activated one of the security blocks as a selected output signal. In addition, a shared comparator generates a comparator signal by comparing the selected output signal with a reference signal. Furthermore, a reset control unit generates a reset signal sent to the micro-computer from the comparator signal.

In an example embodiment of the present invention, at least one register of the smart card is reset and/or operation of a micro-computer is stopped, when the reset signal is activated.

In another embodiment of the present invention, the security apparatus includes a controller having a data processor and a memory device having sequences of instructions stored thereon. Execution of the sequences of instructions by the data processor causes the data processor to perform the steps of:

A. indicating the activated one of the security blocks;

B. generating at least one control signal for coupling a selected set of the at least one shared component to the activated one of the security blocks;

C. generating at least one control signal for controlling the switching unit to select the respective output signal of the activated one of the security blocks as the selected output signal; and

D. repeating steps A, B, and C for cycling through each of the security blocks as the activated one of the security blocks.

In an example embodiment of the present invention, execution of the sequences of instructions by the data processor causes the data processor to perform step D until power to the smart card is terminated.

In this manner, because components are shared among the security blocks, the security apparatus is implemented with fewer components for reduced circuit area and cost of the smart card.

These and other features and advantages of the present invention will be better understood by considering the following detailed description of the invention which is presented with the attached drawings.

### BRIEF DESCRIPTION OF THE DRAWINGS

FIG. 1 shows a block diagram of a security apparatus in a smart card according to the prior art;

FIGS. 2A, 2B, and 2C show circuit diagrams of field effect transistor, resistor, and capacitor units in detectors of the security apparatus of FIG. 1, according to the prior art;

FIG. 3 shows a block diagram of a smart card with a security apparatus according to an embodiment of the present invention;

FIG. 4 shows a block diagram of the security apparatus having detectors with a shared comparator according to an embodiment of the present invention;

FIG. 5 shows a block diagram of the security apparatus having detectors with shared field effect transistors, resistors, and capacitors in a shared block and with a shared comparator, according to an embodiment of the present invention;

FIG. 6 shows a circuit diagram of the shared field effect transistors, resistors, and capacitors in the shared block of FIG. 5, according to an embodiment of the present invention;

FIG. 7 shows a timing diagram of control signals during operation of the security apparatus of FIGS. 4, 5, and 6, according to an embodiment of the present invention; and

FIG. 8 shows a flowchart of steps during operation of the security apparatus of FIGS. 4, 5, and 6, according to an embodiment of the present invention.

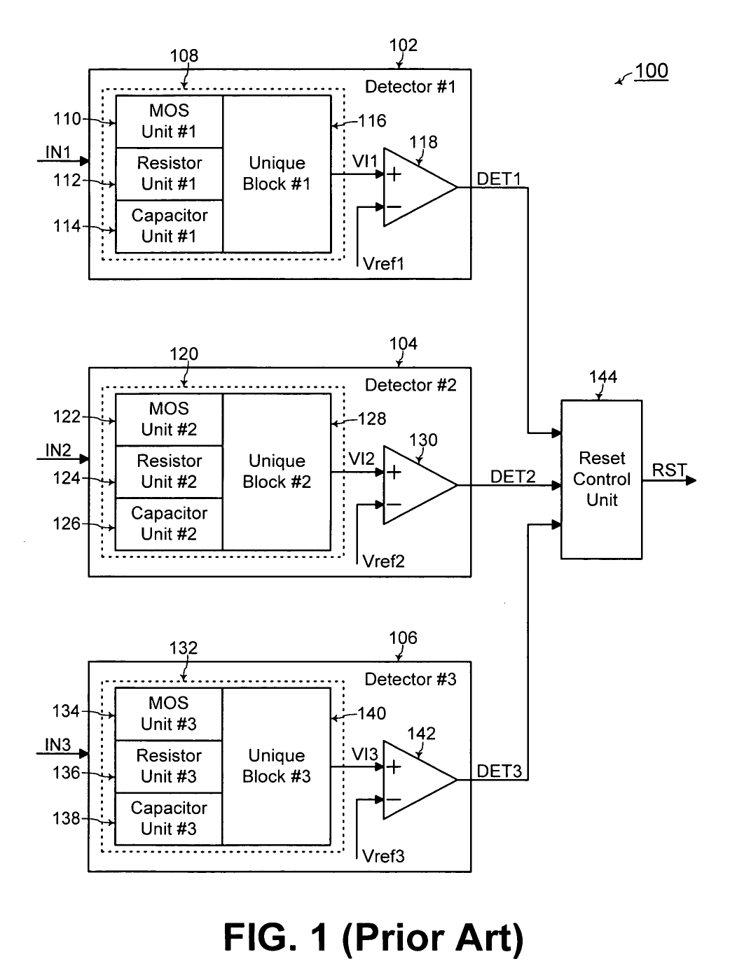

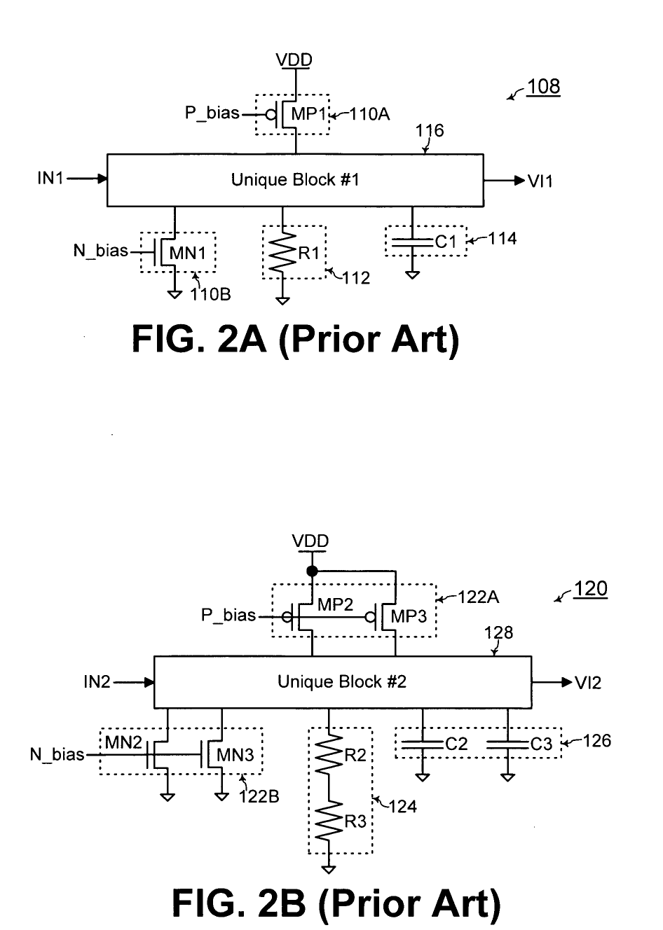

The figures referred to herein are drawn for clarity of illustration and are not necessarily drawn to scale. Elements having the same reference number in FIGS. 1, 2, 3, 4, 5, 6, 7, and 8 refer to elements having similar structure and/or function.

### DETAILED DESCRIPTION

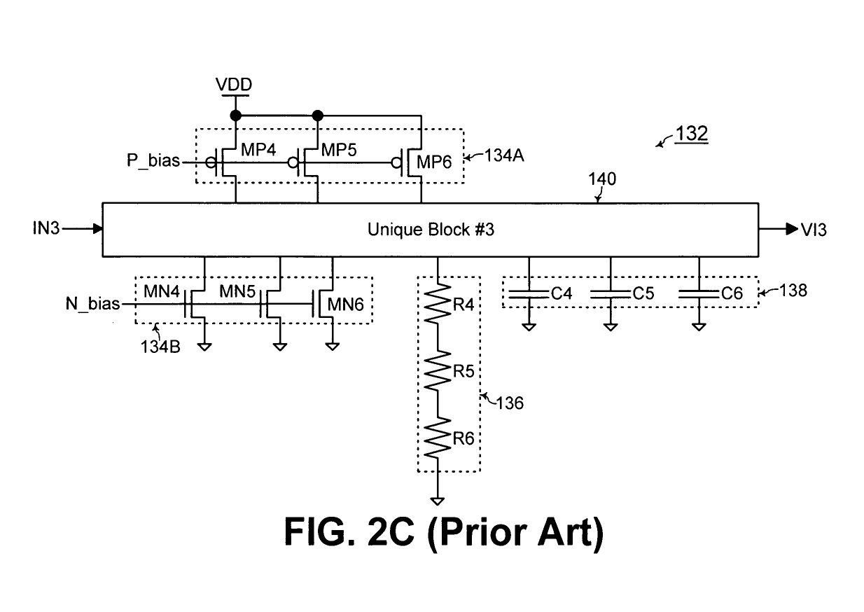

FIG. 3 shows a block diagram of a smart card 200 having a security apparatus 202 with at least one shared component among a plurality of detectors (i.e., a plurality of security blocks) according to an embodiment of the present invention. The smart card 200 also includes a temperature sensor 204, a frequency sensor 206, a light sensor 208, and a register(s) and micro-computer unit 210.

The temperature sensor 204 generates a first input signal IN1 indicating a temperature sensed by the temperature sensor 204. The frequency sensor 206 generates a second input signal IN2 indicating a frequency of a signal sensed by the frequency sensor 206. The light sensor 204 generates a third input signal IN3 indicating an intensity of light sensed by the light sensor 208.

The sensor signals IN1, IN2, and IN3 are received by the security apparatus 202 that generates a reset signal RST from such signals IN1, IN2, and IN3. The security apparatus 202 activates the reset signal RST if any of the sensor signals IN1, IN2, and IN3 is outside of a respective desired range indicating hacker activity for the smart card 200.

The reset signal is received by the micro-computer and registers of the smart card 200. The registers of the smart card 200 are reset and/or operation of the micro-computer is stopped when the reset signal RST is activated for thwarting hacker activity of the smart card 200.

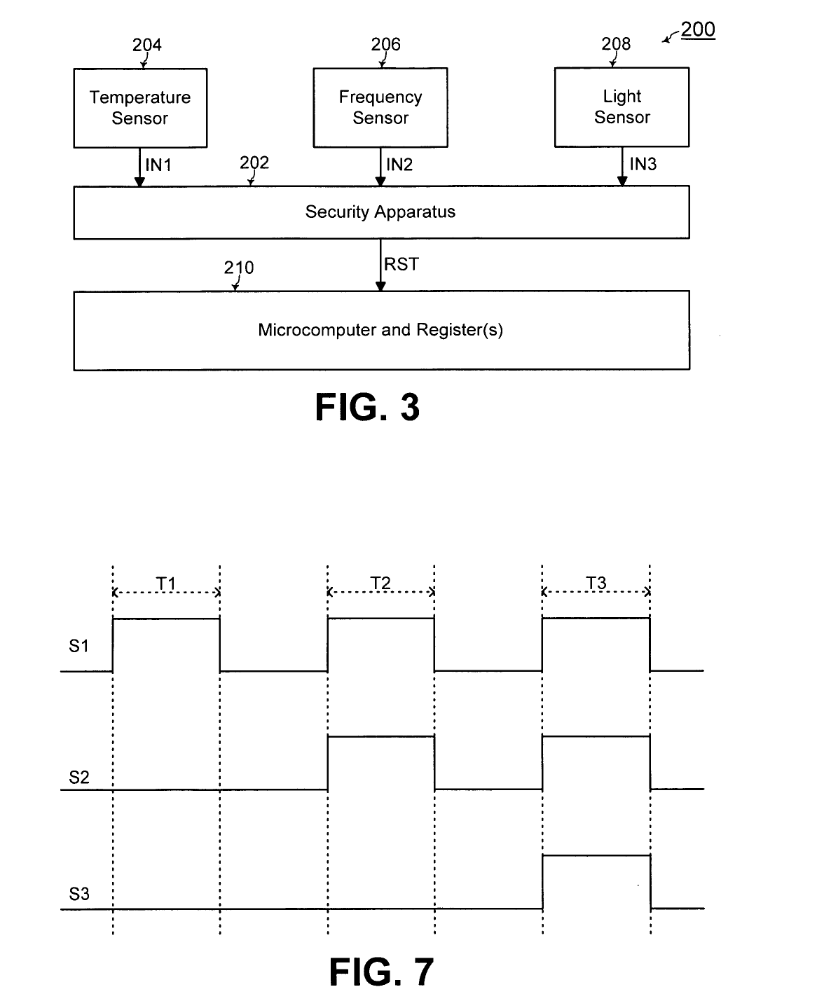

FIG. 4 shows a block diagram of a security apparatus 202A used as the security apparatus 202 of FIG. 3, according to a first embodiment of the present invention. Referring to FIG. 4, the security apparatus 202A includes a detector block 212 having a first detector 214, a second detector 216, and a third detector 218.

The first detector 214 includes a first MOSFET (metal oxide semiconductor field effect transistor) unit 220, a first resistor unit 222, a first capacitor unit 224, and a first unique block 226 of other circuit components. The first detector 214 uses such circuit components to generate a first voltage signal VI1 indicating the magnitude of the temperature from the first input signal IN1.

The second detector 216 includes a second MOSFET unit 228, a second resistor unit 230, a second capacitor unit 232, and a second unique block 234 of other circuit components. The second detector 216 uses such circuit components to generate a second voltage signal VI2 indicating the magnitude of the sensed frequency from the second input signal IN2.

The third detector 218 includes a third MOSFET unit 236, a third resistor unit 238, a third capacitor unit 240, and a third unique block 242 of other circuit components. The third detector 218 uses such circuit components to generate a third voltage signal VI3 indicating the magnitude of the sensed light from the third input signal IN3.

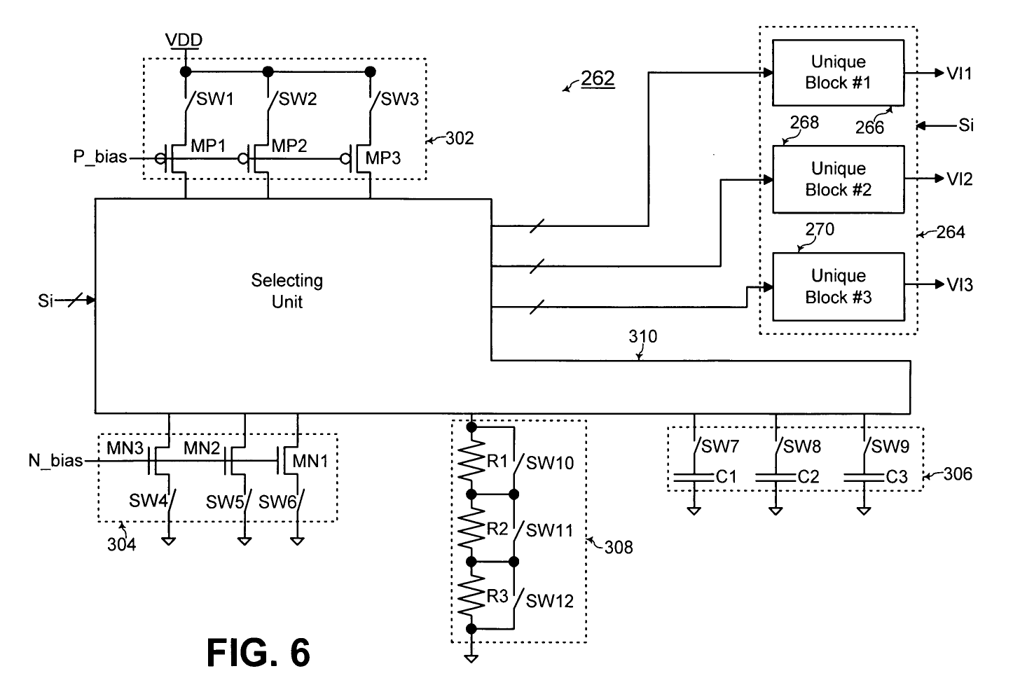

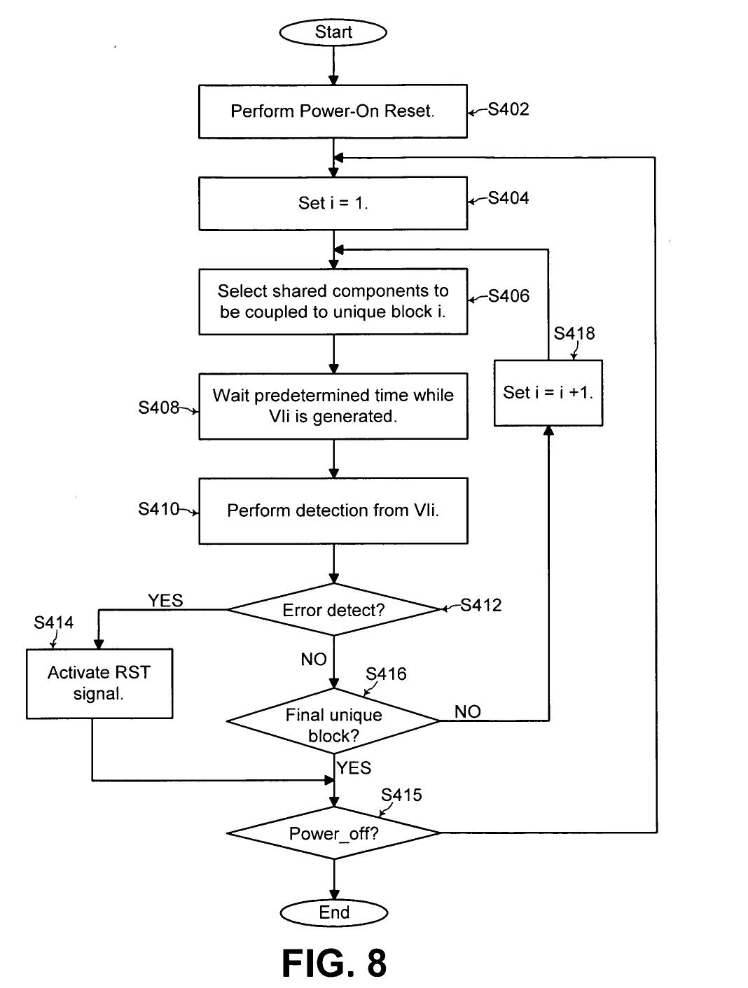

The first, second, and third voltage signals VI1, VI2, and VI3 are input by a detector voltage multiplexer 244 (i.e., an example of a switching unit) that is controlled by at least one control signal Si (such as control signals S1, S2, and S3 illustrated in FIG. 7) from a controller 246. The controller 246 includes a data processor 248 and a memory device 250 having sequences of instructions (i.e., software) stored thereon. Execution of such sequences of instructions by the data processor 248 causes the data processor 248 to perform any steps/operations as will be described later herein for the data processor 248 with respect to the flowchart of FIG. 8.

The control signals Si from the controller 246 determine a selected detector voltage VI as one of the voltage signals VI1, VI2, and VI3 to be output by the detector voltage multiplexer 244. In addition, the security apparatus 202A also includes a reference voltage multiplexer 252 that inputs first, second, and third reference voltages Vref1, Vref2, and Vref3. The control signals Si from the controller 246 determine a selected reference voltage Vref as one of the reference voltage signals Vref1, Vref2, and Vref3 to be output by the reference voltage multiplexer 252.

The first voltage signal VI1 and the first reference voltage Vref1 are simultaneously selected (such as during time period T1 in FIG. 7 when an index i=1 in FIG. 8). Alternatively, the second voltage signal VI2 and the second reference voltage Vref2 are simultaneously selected (such as during time period T2 in FIG. 7 when the index i=2 in FIG. 8). Likewise, the third voltage signal VI3 and the third reference voltage Vref3 are simultaneously selected (such as during time period T3 in FIG. 7 when the index i=3 in FIG. 8).

The security apparatus 202A also includes a shared comparator 254 that receives the selected detector voltage VI and the selected reference voltage Vref for comparison to generate a comparator signal DET. The comparator signal DET is activated to the logical high state if the selected detector voltage VI is greater than the selected reference voltage Vref, and is deactivated to the logical low state otherwise.

Furthermore, a reset control unit 256 generates a reset signal RST from the comparator signal DET. For example, the reset signal RST is activated to the logical high state if the comparator signal DET is activated to the logical high state, and is deactivated other-wise.

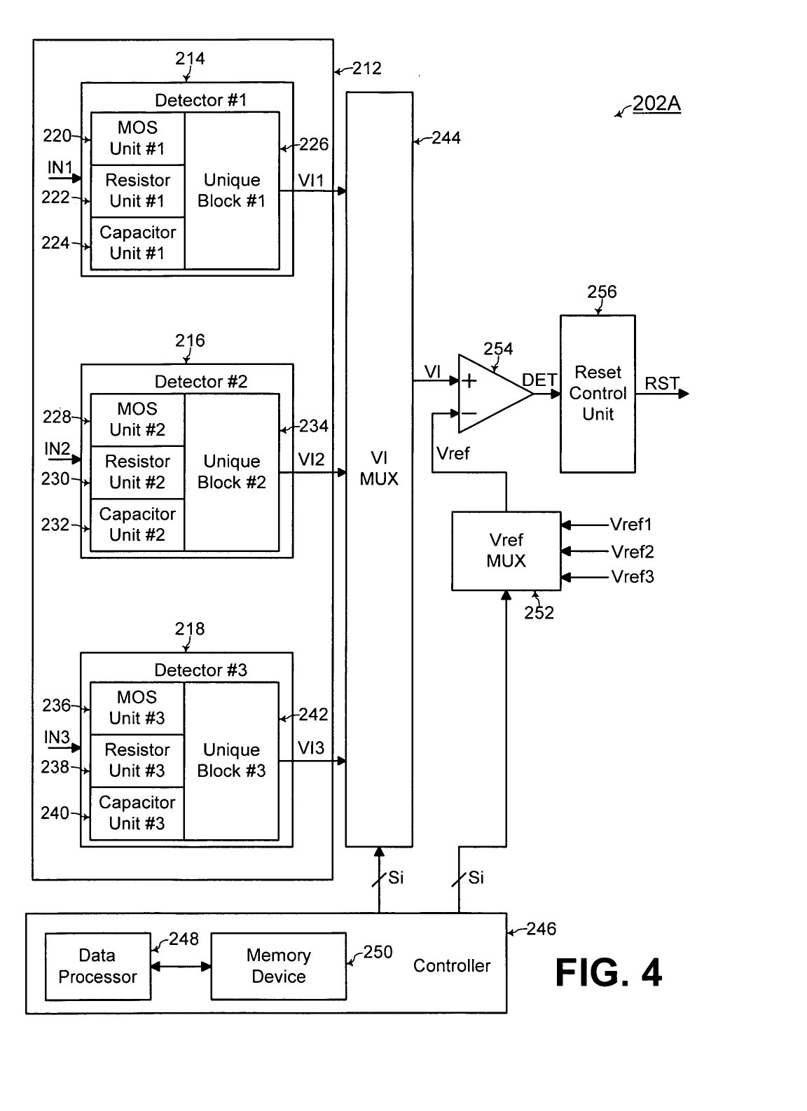

FIG. 5 shows a block diagram of a security apparatus 202B used as the security apparatus 202 of FIG. 3, according to a second embodiment of the present invention. Referring to FIG. 5, the security apparatus 202B includes a common detector block 260 having a shared block 262 of shared transistor, resistor, and capacitor components and a unique block unit 264.

The unique block unit 264 includes a first unique block 266, a second unique block 268, and a third unique block 270 (i.e., a plurality of security blocks). The first unique block 266 has respective non-shared circuit components used with at least a portion of the circuit components of the shared block 262 for generating a first voltage signal VI1 from the first sensor signal IN1.

Similarly, the second unique block 268 has respective non-shared circuit components used with at least a portion of the circuit components of the shared block 262 for generating a second voltage signal VI2 from the second sensor signal IN2. Likewise, the third unique block 270 has respective non-shared circuit components used with at least a portion of the circuit components of the shared block 262 for generating a third voltage signal VI3 from the third sensor signal IN3.

The common detector 260 also includes a detector voltage multiplexer 272 (i.e., an example of a switching unit), a reference voltage multiplexer 274, and a shared comparator 276. The security apparatus 202B also includes a controller 278 and a reset control unit 280.

The first, second, and third voltage signals VI1, VI2, and VI3 are input by the detector voltage multiplexer 272 that is controlled by at least one control signal Si from the controller 278. The controller 278 includes a data processor 282 and a memory device 284 having sequences of instructions (i.e., software) stored thereon. Execution of such sequences of instructions by the data processor 282 causes the data processor 282 to perform any steps/operations as will be described later herein for the data processor 282 with respect to the flowchart of FIG. 8.

The control signals Si from the controller 278 determine a selected detector voltage VI as one of the voltage signals VI1, VI2, and VI3 to be output by the detector voltage multiplexer 272. The reference voltage multiplexer 274 inputs first, second, and third reference voltages Vref1, Vref2, and Vref3. The control signals Si from the controller 278 determine a selected reference voltage Vref as one of the reference voltage signals Vref1, Vref2, and Vref3 to be output by the reference voltage multiplexer 274.

The first voltage signal VI1 and the first reference voltage Vref1 are simultaneously selected (such as during time period T1 in FIG. 7 when an index i=1 in FIG. 8). Alternatively, the second voltage signal VI2 and the second reference voltage Vref2 are simultaneously selected (such as during time period T2 in FIG. 7 when the index i=2 in FIG. 8). Likewise, the third voltage signal VI3 and the third reference voltage Vref3 are simultaneously selected (such as during time period T3 in FIG. 7 when the index i=3 in FIG. 8).

The shared comparator 276 receives the selected detector voltage VI and the selected reference voltage Vref for comparison to generate a comparator signal DET. The comparator signal DET is activated to the logical high state if the selected detector voltage VI is greater than the selected reference voltage Vref, and is deactivated to the logical low state otherwise. The reset control unit 280 generates a reset signal RST from the comparator signal DET. For example, the reset signal RST is activated to the logical high state if the comparator signal DET is activated to the logical high state, and is deactivated other-wise.

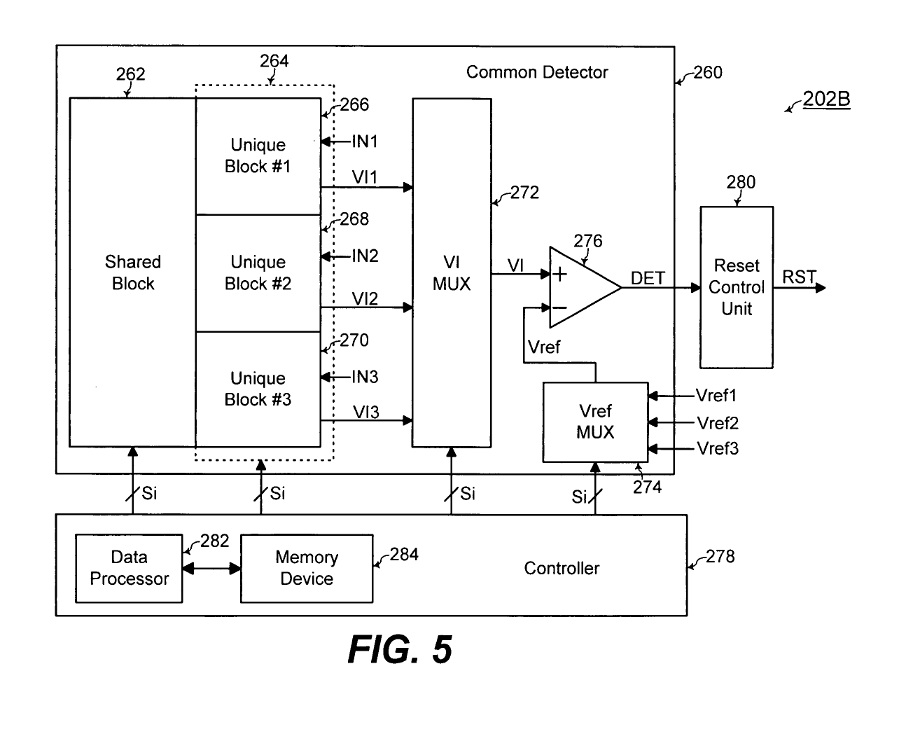

FIG. 6 shows an example of the shared block 262 according to an embodiment of the present invention. The shared block 262 includes a first shared MOSFET (metal oxide semiconductor field effect transistor) unit 302 with a first PMOSFET (P-channel metal oxide semiconductor field effect transistor) MP1, a second PMOSFET MP2, and a third PMOSFET MP3. The shared block 262 also includes a second shared MOSFET unit 304 with a first NMOSFET (N-channel metal oxide semiconductor field effect transistor) MN1, a second NMOSFET MN2, and a third NMOSFET MN3.

The gates of the PMOSFETs MP1, MP2, and MP3 have a first bias voltage P_bias applied thereon. A first switch SW1 is coupled between the first PMOSFET MP1 and a high power voltage supply VDD, a second switch SW2 is coupled between the second PMOSFET MP2 and the high power voltage supply VDD, and a third switch SW3 is coupled between the third PMOSFET MP3 and the high power voltage supply VDD.

The gates of the NMOSFETs MN1, MN2, and MN3 have a second bias voltage N_bias applied thereon. A fourth switch SW4 is coupled between the first NMOSFET MN1 and a ground node, a fifth switch SW5 is coupled between the second NMOSFET MN2 and the ground node, and a sixth switch SW6 is coupled between the third NMOSFET MN3 and the ground node.

The shared block 262 further includes a capacitor unit 306 with a first capacitor C1, a second capacitor C2, and a third capacitor C3. The first capacitor C1 is coupled between a seventh switch SW7 and the ground node, the second capacitor C2 is coupled between an eighth switch SW8 and the ground node, and the second capacitor C3 is coupled between a ninth switch SW9 and the ground node.

The shared block 262 also includes a resistor unit 308 with a first resistor R1, a second resistor R2, and a third resistor R3. A tenth switch SW10 is coupled across the first resistor R1, an eleventh switch SW11 is coupled across the second resistor R2, and a twelfth switch S12 is coupled across the third resistor R3. Such switches SW1, SW2, SW3, SW4, SW5, SW6, SW7, SW8, SW9, SW10, SW11, and SW12 form a switching unit that is controlled for determining which components within the shared block 262 is selected to be coupled to an activated one of the unique blocks 266, 268, and 270.

FIG. 7 illustrates the control signals S1, S2, and S3 generated by the controller 278 for controlling the switches of FIG. 6. The first, fourth, and seventh switches SW1, SW4, and SW7 are controlled to be closed when a first control signal S1 is activated to the logical high state and to be opened otherwise. The tenth switch SW10 is controlled to be closed when the first control signal S1 is deactivated to the logical low state and to be opened otherwise.

Similarly, the second, fifth, and eighth switches SW2, SW5, and SW8 are controlled to be closed when a second control signal S2 is activated to the logical high state and to be opened otherwise. The eleventh switch SW11 is controlled to be closed when the second control signal S2 is deactivated to the logical low state and to be opened otherwise.

Likewise, the third, sixth, and ninth switches SW3, SW6, and SW9 are controlled to be closed when a third control signal S3 is activated to the logical high state and to be opened otherwise. The twelfth switch SW12 is controlled to be closed when the third control signal S3 is deactivated to the logical low state and to be opened otherwise.

The shared block 262 also includes a selecting unit 310 that couples the first and second MOSFET units 302 and 304, the shared capacitor unit 306, and the shared resistor unit 308 to an activated one of the unique blocks 266, 268, and 270 depending on the control signals S1, S2, and S3. One of the unique blocks 266, 268, and 270 is activated depending on the control signals S1, S2, and S3.

For example, when just the first control signal S1 is activated to the logical high state (such as during time period T1 in FIG. 7 when the index i=1 in FIG. 8), the first unique block 266 is activated (while the other unique blocks 268 and 270 are deactivated). In addition during such a time period T1, the selecting unit 310 couples the first PMOSFET MP1, the first NMOSFET MN1, the first resistor R1, and the first capacitor C1 to the activated first unique block 266 for generating the first voltage signal VI1 from the first sensor signal IN1. Also during time period T1 in FIG. 5, the first voltage signal VI1 and the first reference signal Vref1 are selected to be input by the shared comparator 276.

Alternatively, when just the first and second control signals S1 and S2 are activated to the logical high state (such as during time period T2 in FIG. 7 when the index i=2 in FIG. 8), the second unique block 268 is activated (while the other unique blocks 266 and 270 are deactivated). In addition, during such a time period T2, the selecting unit 310 couples the first and second PMOSFETs MP1 and MP2, the first and second NMOSFETs MN1 and MN2, the first and second resistors R1 and R2, and the first and second capacitors C1 and C2 to the activated second unique block 268 for generating the second voltage signal VI2 from the second sensor signal IN2. Also during time period T2 in FIG. 5, the second voltage signal VI2 and the second reference signal Vref2 are selected to be input by the shared comparator 276.

Further, when all of the first, second, and third control signals S1, S2, and S3 are activated to the logical high state (such as during time period T3 in FIG. 7 when the index i=3 in FIG. 8), the third unique block 270 is activated (while the other unique blocks 266 and 268 are deactivated). In addition, during such a time period T3, the selecting unit 310 couples the first, second, and third PMOSFETs MP1, MP2, and MP3, the first, second, and third NMOSFETs MN1, MN2, and MN3, the first, second, and third resistors R1, R2, and R3, and the first, second, and third capacitors C1, C2, and C3 to the activated third unique block 270 for generating the third voltage signal VI3 from the third sensor signal IN3. Also during time period T3 in FIG. 5, the third voltage signal VI3 and the third reference signal Vref3 are selected to be input by the shared comparator 276.

FIG. 8 shows a flowchart of steps during operation of the security apparatus 202A or 202B of FIG. 4 or 5. Referring to FIGS. 4, 5, and 8, the security apparatus 202A or 202B initially performs power-on reset (step S402 of FIG. 8) when registers of the smart card 200 are reset upon power-on. Thereafter, the data processor 248 or 282 initializes the index i=1 (step S404 of FIG. 8).

The index i indicates one of the voltage signals VI1, VI2, and VI3 with the corresponding one of the reference voltages Vref1, Vref2, and Vref3 to be selected for coupling to the shared comparator 254 in FIG. 4 as already described with reference to FIG. 4 (step S406 of FIG. 8). The data processor 248 generates the controls signals S1, S2, and S3 depending on the index i for controlling one of the voltage signals VI1, VI2, and VI3 with the corresponding one of the reference voltages Vref1, Vref2, and Vref3 to be selected for coupling to the shared comparator 254.

Alternatively, the index i indicates which of the shared PMOSFETs MP1, MP2, and MP3, shared NMOSFETs MN1, MN2, and MN3, shared resistors R1, R2, and R3, and shared capacitors C1, C2, and C3 is coupled to the activated one of the unique blocks 266, 268, and 270 as already described with reference to FIGS. 5, 6, and 7 (step S406 of FIG. 8). The data processor 282 generates the controls signals S1, S2, and S3 depending on the index i for controlling which of the shared PMOSFETs MP1, MP2, and MP3, shared NMOSFETs MN1, MN2, and MN3, shared resistors R1, R2, and R3, and shared capacitors C1, C2, and C3 is coupled to the activated one of the unique blocks 266, 268, and 270.

The data processor 248 or 282 waits a predetermined time period (step S408 of FIG. 8) such that the selected voltage signal VIi is stabilized with such a selection of the components. Detection for hacking activity is then performed (step S410 of FIG. 8) by the shared comparator 254 or 276 and the reset control unit 256 or 280.

If the comparator signal DET is activated to the logic high state (step S412 of FIG. 8), the reset control unit 256 or 280 activates the reset signal RST to the logic high state (step S414 of FIG. 8). Thereafter, if power is terminated (step S415 of FIG. 8), the operation of the security apparatus 202A or 202B is terminated. Otherwise, the flowchart of FIG. 8 returns to step S404 with the index being re-initialized (i=1) for continued monitoring of hacking activity.

If the comparator signal DET is not activated (step S412 of FIG. 8), after the data processor 248 or 282 waits the predetermined time period, the data processor 248 or 282 determines whether all of the voltage signals VI1, VI2, and VI3 from all of the unique blocks (226, 234, and 242 in FIG. 4 or 266, 268, and 270 in FIG. 5) have been cycled through for processing (step S416 of FIG. 8). If all of the voltage signals VI1, VI2, and VI3 have not been processed by the shared comparator 254 or 276, the data processor 248 or 282 increments the index i (step S418 of FIG. 8) and generates the control signals S1, S2, and S3 accordingly to return to step S406 of FIG. 8.

If all of the voltage signals VI1, VI2, and VI3 have been processed by the shared comparator 254 or 276 and power is terminated (step S415 of FIG. 8), the operation of the security apparatus 202A or 202B is terminated. Otherwise, the flowchart of FIG. 8 returns to step S404 with the index being re-initialized (i=1) for continued monitoring of hacking activity.

In this manner, all of the voltage signals VI1, VI2, and VI3 are cycled through for being properly generated from all of the unique blocks (226, 234, and 242 in FIG. 4 or 266, 268, and 270 in FIG. 5) and for being processed by the shared comparator 254 or 276. Thus, the security apparatus 202A or 202B effectively monitors for hacking activity of the smart card 200 with shared components such that the security apparatus 202A or 202B may be implemented with lower circuit area and cost.

The foregoing is by way of example only and is not intended to be limiting. For example, any number of elements as illustrated and described herein is by way of example only. The present invention is limited only as defined in the following claims and equivalents thereof.

1. A smart card comprising:
a micro-computer;
a plurality of blocks, each block that when activated generates a respective output signal;
at least one shared component;
a selecting unit for coupling the at least one shared component to the activated one of the blocks; and
a reset control unit for generating a reset signal sent to the micro-computer from the respective output signal.

2. The smart card of claim 1, wherein the activated one of the blocks is a security block that indicates with the respective output signal whether a detected parameter is within an acceptable range.

3. The smart card of claim 2, wherein the reset control unit activates the reset signal when the respective output signal indicates that the detected parameter is not within the acceptable range.

4. The smart card of claim 3, further comprising:
at least one register that receives the reset signal for being reset when the reset signal is activated.

5. The smart card of claim 3, wherein operation of the micro-computer is stopped when the reset signal is activated.

6. The smart card of claim 1, further comprising:
a plurality of components; and
a switching unit for determining which of the plurality of components is coupled to the activated one of the security blocks.

7. The smart card of claim 6, further comprising:
a controller for controlling the switching unit and for selecting the activated one of the blocks

8. The smart card of claim 6, wherein the at least one shared component includes a plurality of resistors, a plurality of capacitors, and a plurality of transistors.

9. The smart card of claim 1, further comprising:
a switching unit that selects the respective output signal from the activated one of the blocks as a selected output signal; and
a shared comparator for generating a comparator signal by comparing the selected output signal with a reference signal,
wherein the reset control unit generates the reset signal from the comparator signal.

10. The smart card of claim 9, further comprising:
a controller including a data processor and a memory device having sequences of instructions stored thereon, and wherein execution of the sequences of instructions by the data processor causes the data processor to perform the steps of:
A. indicating the activated one of the blocks;
B. generating at least one control signal used for coupling a selected set of the at least one shared component to the activated one of the blocks;
C. generating at least one control signal for controlling the switching unit to select the respective output signal of the activated one of the blocks as the selected output signal; and
D. repeating steps A, B, and C for cycling through each of the blocks as the activated one of the blocks.

11. The smart card of claim 10, wherein execution of the sequences of instructions by the data processor causes the data processor to perform the further step of:
performing step D until power to the smart card is terminated.

12. The smart card of claim 1, wherein the at least one shared component is a comparator that generates a comparator signal by comparing the respective output signal of the activated one of the blocks with a reference signal, and wherein reset control unit generates the reset signal from the comparator signal.

13. The smart card of claim 12, wherein the reference signal is respective reference signal for the activated one of the blocks.

14. The smart card of claim 1, further comprising a data processor and a memory device having sequences of instructions stored thereon, and wherein execution of the sequences of instructions by the data processor causes the data processor to perform the steps of:
A. generating at least one control signal for indicating the activated one of the blocks; and
B. repeating step A for cycling through each of the blocks as the activated one of the blocks.

15. A security apparatus within a smart card, comprising:
a plurality of security blocks, each security block that when activated generates a respective output signal indicating whether a respective detected parameter is within a respective acceptable range;
at least one shared component; and
a selecting unit for coupling the at least one shared component to the activated one of the security blocks.

16. The security apparatus of claim 15, further comprising:
a plurality of components; and
a switching unit for determining which of the plurality of components is coupled to the activated one of the security blocks.

17. The security apparatus of claim 16, wherein the plurality of components includes a plurality of resistors, a plurality of capacitors, and a plurality of transistors.

18. The security apparatus of claim 15, further comprising:
a switching unit that selects the respective output signal from the activated one of the security blocks as a selected output signal;
a shared comparator for generating a comparator signal by comparing the selected output signal with a reference signal; and
a reset control unit for generating a reset signal sent to the micro-computer from the comparator signal.

19. The security apparatus of claim 18, wherein at least one register of the smart card is reset when the reset signal is activated.

20. The security apparatus of claim 18, wherein operation of a micro-computer is stopped when the reset signal is activated.

21. The security apparatus of claim 18, further comprising a controller including a data processor and a memory device having sequences of instructions stored thereon, and wherein execution of the sequences of instructions by the data processor causes the data processor to perform the steps of:
A. indicating the activated one of the security blocks;
B. generating at least one control signal for coupling a selected set of the at least one shared component to the activated one of the security blocks;
C. generating at least one control signal for controlling the switching unit to select the respective output signal of the activated one of the security blocks as the selected output signal; and
D. repeating steps A, B, and C for cycling through each of the security blocks as the activated one of the security blocks.

22. The security apparatus of claim 21, wherein execution of the sequences of instructions by the data processor causes the data processor to perform the further step of:
performing step D until power to the smart card is terminated.

23. The security apparatus of claim 15, wherein the at least one shared component is a comparator that generates a comparator signal by comparing the respective output signal with a reference signal.

24. The security apparatus of claim 23, wherein the reference signal is a respective reference signal for the activated one of the security blocks.

25. The security apparatus of claim 15, further comprising a controller including a data processor and a memory device having sequences of instructions stored thereon, and wherein execution of the sequences of instructions by the data processor causes the data processor to perform the steps of:
A. generating at least one control signal for indicating the activated one of the security blocks; and
B. repeating step A for cycling through each of the security blocks as the activated one of the security blocks.
